(19) United States
(12) Patent Application Publication
(10) Pub. No.: US 2007/0115266 A1
(43) Pub. Date: May 24, 2007

(54) PORTABLE DEVICE FOR CONTROLLING A COMPUTER AND METHOD THEREFOR

(75) Inventors: Robert Han Liu, Shenzhen (CN); Tay-Yang Lin, Shenzhen (CN); Kuan-Hong Hsieh, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,832

(22) Filed: Oct. 9, 2006

(30) Foreign Application Priority Data
Nov. 18, 2005 (CN) 200510101512.8

(51) Int. Cl. G09G 5/00

(52) U.S. Cl. 345/173

(57) ABSTRACT

A method for controlling a computer via a portable device is provided. The method includes the steps of: providing an input unit configured in the portable device for operational inputs; providing an operation interface for selecting either one of a computer controlled mode and a portable device controlled mode if the portable device is connected to the computer, wherein the input unit serves as an input unit for the computer in the computer controlled mode, and the input unit serves the audio signal generating device in the portable device controlled mode; receiving an operational input from the input unit, and generating a control signal corresponding to the operational input; translating the control signal to a control instruction according to input mappings and transmitting the control instruction to the computer, if the input unit of the portable device is in the computer controlled mode; and performing operations corresponding to the control instruction. A portable device for controlling a computer is also provided.

### TECHNICAL FIELD

The present invention relates generally to portable devices, and particularly to a portable device for controlling a computer and method therefor.

### GENERAL BACKGROUND

With the development of the computer technology, touchpads have become a necessary input device of a notebook. A touchpad allows a user of the notebook to exclude to bring the mouse combined therewith when taking the notebook to a remote location.

However, the touchpad is not convenient for user operations, thereby resulting in more work for user's operation, and causing the user to eagerly desire a mouse connected to the notebook. Usually, the user would opt for a small wireless mouse to operate the notebook. However, the wireless mouse generates a signal delay, a delay that does not meet the user's need for efficiency, especially when the user plays an intense game.

Additionally, with cheaper accessibility to other technological gadgets, people who likes listening to music via an audio signal generating device would further bring along the audio signal generating device when taking the notebook to a remote location. It is inconvenient for a user if the notebook, the mouse, and the audio signal generating device needs to be brought together.

Therefore, what is needed is a portable device for controlling a computer and method therefor to overcome the above-described problem.

### SUMMARY

A portable device for controlling a computer is provided. The computer has a central processing unit (CPU) and a computer interface. The portable device includes a device interface; an input unit for receiving an operational input, and for generating a control signal corresponding to the operational input; a microcontroller unit (MCU) electrically connected to the device interface and the input unit; an operation interface for selecting either one of a computer controlled mode and a portable device controlled mode if the device interface is connected to the computer interface, wherein the input unit serves as an input unit for the computer in the computer controlled mode, and the input unit serves the audio signal generating device in the portable device controlled mode; wherein the MCU translates the control signal into a control instruction according to input mappings and transmits the control instruction to the computer via the computer interface in the computer controlled mode, and the CPU executes the control instruction.

A method for controlling a computer via a portable device is also provided. The method includes the steps of: (a) providing an input unit configured in the portable device for operational inputs; (b) providing an operation interface for selecting either one of a computer controlled mode and a portable device controlled mode if the portable device is connected to the computer, wherein the input unit serves as an input unit for the computer in the computer controlled mode, and the input unit serves the audio signal generating device in the portable device controlled mode; (c) receiving an operational input from the input unit, and generating a control signal corresponding to the operational input; (d) translating the control signal to a control instruction according to input mappings and transmitting the control instruction to the computer, if the input unit of the portable device is in the computer controlled mode; and (e) performing operations corresponding to the control instruction.

Other advantages and novel features will be drawn from the following detailed description of the embodiments with reference to the attached drawings, in which:

### BRIEF DESCRIPTION OF DRAWINGS

FIG. 1 is an application schematic diagram of a portable device for controlling a computer in accordance with a first preferred embodiment of the present invention;

FIG. 2 is a flowchart of a preferred method for controlling a computer via the portable device of FIG. 1;

FIG. 3 is a flowchart of controlling a notebook to perform operations after one step of the method of FIG. 2, namely, entering into a notebook controlled mode; and

FIG. 4 is an application schematic diagram of a portable device for controlling a computer in accordance with a second preferred embodiment of the present invention.

### DETAILED DESCRIPTION

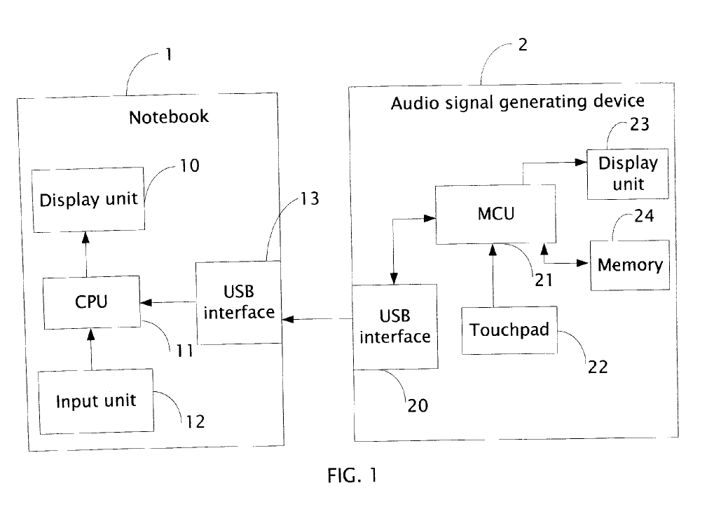

FIG. 1 is an application schematic diagram of a portable device for controlling a computer in accordance with a first preferred embodiment of the present invention. The computer can be a personal computer (PC) or a notebook. In this exemplary embodiment as shown in FIG. 1, a notebook 1 is adopted as an example, and an audio signal generating device 2 is taken as an example of the portable device.

The notebook 1 includes a display unit 10, a central processing unit (CPU) 11, an input unit 12, and a universal serial bus (USB) interface 13. The audio signal processing device 2 includes a USB interface 20, a microcontroller unit (MCU) 21, an input unit 22, a display unit 23, and a memory 24. In the preferred embodiment, the input unit 22 takes a touchpad as an example.

The audio processing device 2 further includes an operation interface (not shown). The operation interface is used for selecting a controlled mode, and can be in a menu option form or a key form. In the first preferred embodiment, the former is adopted as an example. When the USB interface 20 of the audio signal generating device 2 connects to the USB interface 13 of the notebook 1, the MCU 21 is configured for controlling the display unit 23 to display a plurality of menu options. The menu options include a notebook controlled mode menu option label and an audio signal generating device controlled mode menu option label allowing a user to select either a notebook controlled mode or an audio signal generating device controlled mode. The touchpad 22 is operable to receive operational inputs, thus enabling a corresponding controlled mode. When the notebook controlled mode menu option label is selected, the touchpad 22 of the audio signal generating device 2 serves as a mouse, i.e. an input unit of the notebook 1. Accordingly, the notebook 1 performs corresponding operations in response to operational inputs received by the touchpad 22 of the audio signal generating device 2 in the notebook controlled mode. Alternatively, when the audio signal generating device controlled mode menu option label is selected, the touchpad 22 of the audio signal generating device 2 explicitly serves the audio signal generating device 2. Accordingly, the audio signal generating device 2 performs corresponding operations in response to operational inputs received by the touchpad 22.

In this exemplary embodiment, the touchpad 22 preferably includes a rotational input unit and a button disposed in the center or middle of the rotational input device (not shown). In the notebook controlled mode, the touchpad 22 can identify four kinds of operational inputs, and generate a control signal corresponding to each operational input. For example, when the button is clicked one time, the touchpad 22 processes the operational input as a single click on a left key of a mouse (not shown); when the button is clicked two times, the touchpad 22 processes the operational input as a double click on a right key of the mouse; when the rotational input unit is rotated in a clockwise direction, the touchpad 22 processes the operational input as a forward scroll movement on a scroll wheel of the mouse; when the rotational input unit is rotated in a counterclockwise direction, the touchpad 22 processes the operational input as a backward scroll movement on the scroll wheel of the mouse. Each processing manner can be regarded as an input mapping between the touchpad 22 and the mouse. In other preferred embodiments, the input unit 22 is different from the touchpad 22, accordingly, each operational input on the input unit 22 can be processed according to corresponding input mappings between operational inputs on the input unit 22 and operational inputs on the mouse.

The MCU 21 translates the control signal into a corresponding control instructions according to the above-described input mappings, and transmits the control instructions to the notebook 1 via the USB interface 20. The control instructions can be recognized by the notebook 1.

The CPU 11 receives the control instructions via the USB interface 13, and executes the control instructions. In the preferred embodiment, when the audio signal generating device 2 is selective to work in the notebook controlled mode, the input unit 12 of the notebook 1 and the touchpad 22 of the audio signal generating device 2 can both be used simultaneously to perform operational inputs on the notebook 1. The display unit 10 is provided for displaying a user interface.

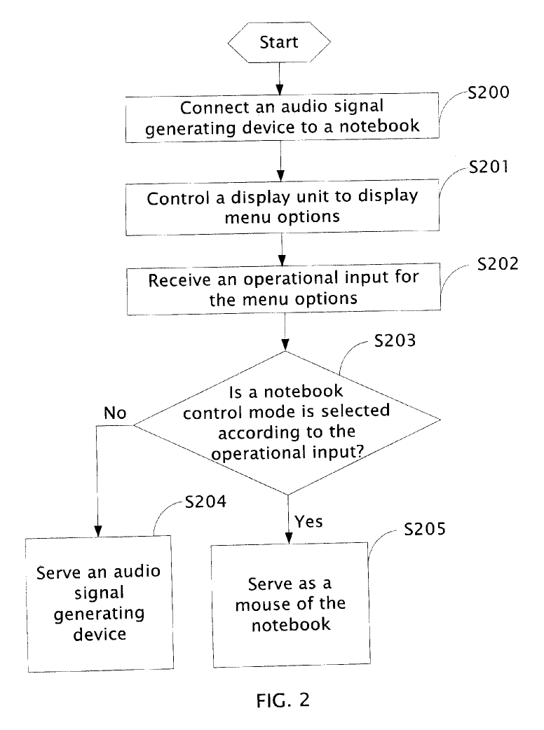

FIG. 2 is a flowchart of a preferred method for controlling a computer via the portable device of FIG. 1. In step S200, the audio signal generating device 2 connects to a USB interface 13 of the notebook 1 via the USB interface 20 thereof. In step S201, the MCU 21 controls the display unit 23 to display menu options. The menu options include the notebook controlled mode menu option label and the audio signal generating device controlled mode menu option label allowing a user to select either one of the notebook controlled mode and the audio signal generating device controlled mode of the audio signal generating device 2. In step S202, the touchpad 22 receives an operational input for the menu options. In step S203, the MCU 21 determines whether the notebook controlled mode is selected according to the operational input. If so, in step S205, the touchpad 22 of the audio signal generating device 2 in the notebook controlled mode serves as the mouse of the notebook 1, and the notebook 1 performs corresponding operations in response to operational inputs received by the touchpad 22 of the audio signal generating device 2. Otherwise, in step S204, the touchpad 22 of the audio signal generating device 2 explicitly serves the audio signal generating device 2.

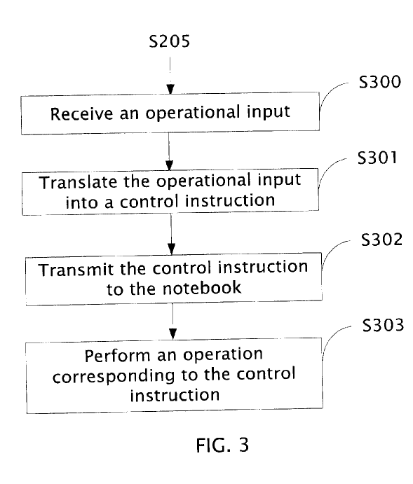

FIG. 3 is a flowchart of a described-above step S205 of FIG. 2, namely, performing corresponding operations under the notebook controlled mode in response to operational inputs received by the touchpad 22. In step S300, the touchpad 22 receives an operational input, and generates a corresponding control signal. In step S301, the MCU 21 translates the control signal into the control instructions according to the above-described input mappings. In step S302, the MCU 21 transmits the control instructions to the notebook 1. In step S303, the CPU 11 of the notebook 1 receives the control instructions via the USB interface 13 thereof, and performs the operation corresponding to the control instructions.

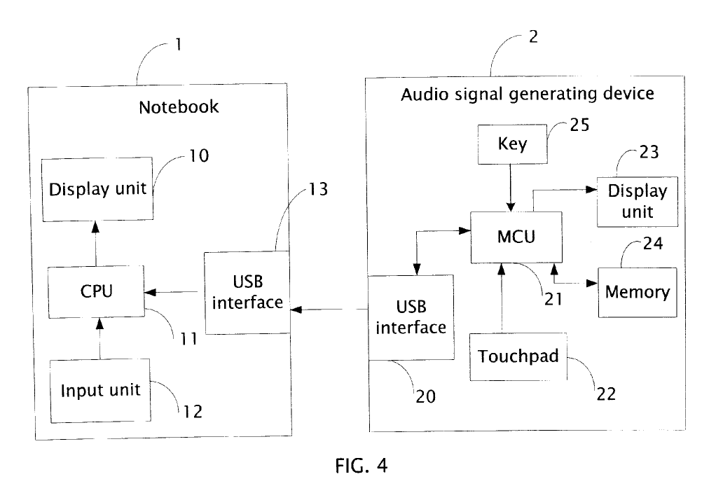

FIG. 4 is an application schematic diagram of a portable device for controlling a computer (hereafter, “the portable device”) in accordance with a second preferred embodiment of the present invention. The portable device of the second preferred embodiment is the same as that of the first preferred embodiment, except that a key 25 is included in the audio signal generating device 2. In the second preferred embodiment, the operation interface is in a key form.

When the USB interface 20 of the audio signal generating device 2 connects to the USB interface 13 of the notebook 1, and the key 25 receives an operational input, the MCU 21 controls the touchpad 22 to enter a computer controlled mode according to the operational input. In the notebook controlled mode, the touchpad 22 of the audio signal generating device 2 serves as a mouse, i.e. an input unit of the notebook 1. Accordingly, the notebook 1 performs corresponding operations in response to operational inputs received by the touchpad 22 of the audio signal generating device 2 in the notebook controlled mode. When the key 25 receives an operation input again, the touchpad 22 of the audio signal generating device 2 explicitly serves the audio signal generating device 2. Accordingly, the audio signal generating device 2 performs corresponding operations in response to operational inputs received by the touchpad 22.

Although the present invention has been specifically described on the basis of the preferred embodiment including the preferred method, the invention is not to construed as being limited thereto. Various changes or modifications may be made to the embodiment including the method without departing from the scope and spirit of the invention.

What is claimed is:

1. A portable device for controlling a computer which has a central processing unit (CPU) and a computer interface, the portable device comprising:
a device interface;
an input unit for receiving an operational input, and for generating a control signal corresponding to the operational input;
a microcontroller unit (MCU) electrically connected to the device interface and the input unit;
an operation interface for selecting either one of a computer controlled mode and a portable device controlled mode if the device interface is connected to the computer interface, wherein the input unit serves as an input unit for the computer in the computer controlled mode, and the input unit serves the audio signal generating device in the portable device controlled mode;
wherein the MCU translates the control signal into a control instruction according to input mappings and transmits the control instruction to the computer via the computer interface in the computer controlled mode, and the CPU executes the control instruction.

2. The portable device as described in claim 1, wherein the MCU performs the operation corresponding to the control signal in the portable device controlled mode.

3. The portable device as described in claim 1, wherein a form of the operation interface is selected from a menu option form and a key form.

4. The portable device as described in claim 1, further comprising a memory for storing the input mappings for the operational input.

5. A method for controlling a computer via a portable device, the method comprising the steps of:
providing an input unit configured in the portable device for operational inputs;
providing an operation interface for selecting either one of a computer controlled mode and a portable device controlled mode if the portable device is connected to the computer, wherein the input unit serves as an input unit for the computer in the computer controlled mode, and the input unit serves the audio signal generating device in the portable device controlled mode;
receiving an operational input from the input unit, and generating a control signal corresponding to the operational input;
translating the control signal to a control instruction according to input mappings and transmitting the control instruction to the computer, if the input unit of the portable device is in the computer controlled mode; and
performing operations corresponding to the control instruction.

6. The method as described in claim 5, wherein a form of the operation interface is selected from a menu option form and a key form.
